(19) United States
(12) Patent Application Publication
(10) Pub. No.: US 2014/0277697 A1
(43) Pub. Date: Sep. 18, 2014

(54) TRANSPORT SYSTEM WITH AT LEAST ONE POSITION SENSOR

(71) Applicants: Raymond Francis McDonald, L'Anse, MI (US); Daniel Carl Luoma, Chassell, MI (US)

(72) Inventors: Raymond Francis McDonald, L'Anse, MI (US); Daniel Carl Luoma, Chassell, MI (US)

(21) Appl. No.: 13/837,401

(22) Filed: Mar. 15, 2013

(51) Int. Cl. B66F 9/075

(52) U.S. Cl. CPC B66F 9/0755
USPC 700/228

(57) ABSTRACT

A system for transporting an object comprises a first cylinder that is movable to cause movement of a first component of the system. A first sensor is operable to acquire position information related to a position of at least one of the first cylinder, the first component, or another component of the system. The system comprises an automated mode in which the position information provided by the first sensor is used to determine movement of the first component of the system.

### BACKGROUND

The present embodiments relate generally to a transport system, such as an extendable forklift.

Transport machines, such as extendable boom forklifts or other telehandling machines with different attachments, may include multiple cylinders that can be actuated to ultimately position an attachment, e.g., a fork frame, generally through a series of booms. Typically, an operator sits in an operator cab having a joystick, which is movable in four directions in order to achieve horizontal and vertical movements of the attachment from a first position to a second position.

When positioning a load on a fork frame at a height in a typical manual operating mode, a user must multi-function the lifting and extension functions of the joystick in an attempt to position the fork frame at the correct location, and also to remove the fork tines from a pallet. Such multi-function of the lifting and extension functions, in order to achieve desired movement, can be challenging even with an experienced operator. Moreover, such multi-function movements may be jerky, and generally result in movements that are not in the desired linear direction, such as truly horizontal nor truly vertical. This may present logistic and safety issues, particularly when attempting to horizontally retract fork tines from a pallet.

Prior attempts have been made to provide an operator of a transport machine the ability to more accurately position a load, e.g., disposed on a fork frame. For example, certain attempts have been made to assist movement of the fork frame in truly horizontal and vertical directions. However, such attempts have generally required the use of complex mechanical devices, including numerous additional gears, shafts, and other components, which add to the complexity, cost, and potential accuracy of the device. Moreover, such mechanisms may offer the ability to assist movement in only one of the horizontal or vertical directions. Still further, accuracy in the assisted movement may be compromised by the failure to provide real-time feedback.

### SUMMARY

A system for transporting an object comprises a first cylinder that is movable to cause movement of a first component of the system. A first sensor is operable to acquire position information related to a position of at least one of the first cylinder, the first component, or another component of the system. The system comprises an automated mode in which the position information provided by the first sensor is used to determine movement of the first component of the system.

In one embodiment, at least one boom is provided, and the at least one boom and the first cylinder are operatively coupled to a fork frame to achieve movement of the fork frame. Truly horizontal and vertical movement of the fork frame may be achieved using the position information provided by the first sensor.

In various embodiments, the first sensor may be operatively coupled to a boom cylinder and a second sensor may be operatively coupled to a lift cylinder. The first and second sensors may comprise one of a linear transducer or a string potentiometer. In one embodiment, at least one additional sensor is coupled to a main frame of the system and is operable to acquire position information related to a slope of the main frame.

The system further may comprise a manual operation mode, wherein the user is able to manually direct movements of the first component of the system by operating a joystick in the manual operation mode. The joystick may comprise a button that is operable to automatically switch between the manual operation mode and the automated mode.

Advantageously, the present embodiments provide an operator with additional control of a transport machine, for example, by simplifying lifting, landing and other movement operations. For example, when using the automated operation mode, a user can simply move the joystick in one desired direction to precisely move a component, such as a fork frame, via automated flow distribution as described herein. Further, a user may maintain the choice of whether to use the manual mode or the automated mode, e.g., by pressing a button on the joystick. As yet a further advantage, the present embodiments may also take slope of the ground into consideration in determining movement of components.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIGS. 1A-1B are side views depicting horizontal movement of a fork frame in a manual operation mode with outriggers retracted and deployed, respectively, and FIGS. 1C-1D are side views depicting vertical movement of the fork frame in a manual operation mode with outriggers retracted and deployed, respectively.

FIGS. 2A-2B are side views depicting horizontal movement of a fork frame in a automated operation mode with outriggers retracted and deployed, respectively, and FIGS. 2C-2D are side views depicting vertical movement of the fork frame in an automated operation mode with outriggers retracted and deployed, respectively.

FIGS. 3A-3B are side views depicting horizontal movement of a fork frame in a automated operation mode on an inclined slope with outriggers retracted and deployed, respectively, and FIGS. 3C-3D are side views depicting vertical movement of the fork frame in an automated operation mode on an inclined slope with outriggers retracted and deployed, respectively.

FIGS. 4-6 are perspective views illustrating different exemplary sensor placements.

FIGS. 7A-7B are perspective and side views, respectively, of features of an exemplary joystick.

FIG. 8 is a block diagram depicting relationships between selected components of the system.

FIG. 9 is a flowchart depicting an exemplary automated operation mode of the system.

### DETAILED DESCRIPTION OF THE PREFERRED EMBODIMENTS

Referring to FIGS. 1A-1D, an exemplary transport machine 20 is shown in a series of positions based on a manual user operation mode. The transport machine 20 may comprise an attachment, by way of example and without limitation, such as a fork frame 30 having fork tines 37, which is used to transport an object from one location to another. The transport machine 20 further comprises a main frame 22, an operator cab 24, a plurality of wheels 26, and outriggers 27, as shown in FIG. 1A. The transport machine 20 further comprises a plurality of boom members, coupled between the main frame 22 and the fork frame 30, that are movable in different directions. A series of hydraulic cylinders, some of which are illustrated further in FIGS. 4-6 below, control the movement of the various components of transport machine 20 to cause desirable movement of the fork frame 30 and the object that it carries.

In FIGS. 1A-1B, the fork frame 30 of the machine 20 is shown being movable from a first position 30a to a second position 30b by extension of a boom cylinder 40. Upon outward extension of the boom cylinder 40, one or more smaller booms 44 may move distally with respect to a large boom 42, as is generally known. It should be noted that, upon actuation of extension of the boom cylinder 40, the fork frame 30 moves from the first position 30a to the second position 30b in directions that are neither truly horizontal nor truly vertical to a horizontally flat ground surface 10.

In FIGS. 1C-1D, the fork frame 30 of the machine 20 is shown being movable from a first position 31a to a second position 31b and to a third position 31c by extension of a lift cylinder 50, which is shown in FIGS. 4-6 (it is noted that the lift cylinder 50 is omitted from portions of FIGS. 1-3 for illustrative clarity). The lift cylinder 50 is positioned between the main frame 22 and a rear portion of the large boom 42, as shown in FIGS. 4-6. The lift cylinder 50 pivots the large boom 42, and associated smaller booms 44, about a pivot location to control the angle of the boom sections relative to the main frame 22, and thereby the elevation of the fork tines 37. It should be noted that, upon actuation of extension of the lift cylinder 50, the fork frame 30 moves from the first position 31a to the second position 31b and then to the third position 31c, which are directions that are neither truly horizontal nor truly vertical to the horizontally flat ground surface 10.

The movement pathways shown in FIGS. 1A-1D are examples of movement of the fork frame 30 of the machine 20 based on manual user operation using a joystick 80, as shown in FIGS. 7A-7B. The joystick 80 is located in the operator cab 24. By moving the joystick 80 in a first direction 81a, such as pushing forward, the lift cylinder 50 may be retracted such that downward movement of the fork tines 37 is achieved. By moving the joystick 80 in a second direction 81b, such as pulling downward, the lift cylinder 50 may be extended such that upward movement of the fork tines 37 is achieved. By moving the joystick 80 in third and fourth directions 81c and 81d, such as left and right, respectively, the boom cylinder 40 may be retracted or extended, respectively, such that retraction or extension of the fork tines 37 is achieved. Fluid flow is regulated through a series of valves in order to increase or decrease flow to the cylinders, based on the movements imparted to the joystick 80. It is noted that the joystick 80 further comprises a button 82 for enabling or disabling an automated operation mode, as described in further detail below, and also may comprise buttons 84 and 86 as shown in FIGS. 7A-7B for actuating a fork tilt mechanism and actuating an auxiliary circuit, respectively.

It will be appreciated that while the boom cylinder 40 and the lift cylinder 50 are shown at certain locations in FIGS. 1-6, the precise locations of the boom cylinder 40 and the lift cylinder 50 may be adjusted without departing from the invention. Moreover, while only one boom cylinder 40 and one lift cylinder 50 are shown herein, it will be appreciated that additional cylinders may be provided. As one non-limiting example, a tilt cylinder may be coupled between the fork frame 30 and the end of a small boom 44 in order to control the angular orientation of the fork tines 37.

Referring now to FIGS. 2A-2D, the transport machine 20 is shown in a series of positions based on an automated operation mode. In the operational mode of FIGS. 2A-2D, the fork frame 30 and the fork tines 37 may be moved in a predetermined direction automatically, such as a truly horizontal or truly vertical position relative to the flat ground surface 10.

In FIGS. 2A-2B, the fork frame 30 of the machine 20 is shown being movable from a first position 32a to a second position 32b, in a truly horizontal manner relative to the flat ground surface 10, by an automated series of movements that maintain the fork frame 30 level during movement.

In accordance with one aspect, at least one sensor is coupled to a portion of the transport machine 20 that ascertains the present position of a portion of the machine 20. For example, in the embodiment of FIG. 4, a first sensor 70 may be coupled to a rear portion of the boom 42 and a second sensor 72 may be coupled to the lift cylinder 50. In the alternative embodiment of FIG. 5, the first sensor 70 may be coupled to the boom cylinder 40, while the second sensor 72 remains coupled to the lift cylinder 50.

In one embodiment, the first sensor 70 may comprise a string potentiometer, known in the art, which measures a position of the boom cylinder 40, the large boom 42, and/or the smaller booms 44, depending on placement of the first sensor 70. The information determined by the first sensor 70 is provided to a controller 110, shown in FIG. 8 below, which notes the position of the boom cylinder 40, the large boom 42, and/or the smaller booms 44.

The second sensor 72 may comprise a linear transducer, known in the art, which may measure a position of the lift cylinder 50. A suitable linear transducer, which may be used as the second sensor 72, is manufactured by Rota Engineering Limited of Manchester, United Kingdom. The information determined by the second sensor 72 is provided to the controller 110, which notes the position of the lift cylinder 50.

A control program or algorithm of the controller 110 is operable to utilize the information provided by at least one of the sensors, and preferably both the first and second sensors 70 and 72, to determine the precise current positioning of the various components of the machine 20, including position of the fork frame 30 and the fork tines 37.

In one embodiment, input and output capability (I/O) is added to the controller 110, as described further in FIG. 8 below. Optionally, controllers of existing transport machines 20 may be updated to accept the additional I/O. Other hardware, such as a computer or other logic device, may also be employed to accept the additional I/O. The additional I/O accepts inputs from the sensors, such as first and second sensors 70 and 72, to provide the controller real-time position of the various components of the machine 20.

When in the automated operation mode of FIGS. 2A-2D, the controller 110 is operable to use the current position information to perform selected movements. In one example, the automated operation mode uses the position of multiple cylinders as inputs to the controller 110, in order to control multiple valves through the controller 110, as described in FIG. 8 below.

As one non-limiting example, shown in FIGS. 2A-2B, a user may wish to advance the fork frame 30 and the fork tines 37 in a truly horizontal manner from a first location 32a to a second location 32b. With the automated mode of the joystick 80 activated by pressing the button 82, the user simply needs to move the joystick 80 in the fourth direction 81d, as shown in FIG. 7A, in order to achieve a truly horizontal extension of the fork tines 37, as illustrated in FIGS. 2A-2B. More particularly, movement of the joystick 80 in the fourth direction 81d sends an input command to the controller 110, as shown in FIG. 8, to direct a truly horizontal extension of the fork tines 37, and the controller 110 is programmed to manipulate fluid flow to selected cylinders accordingly to achieve such movement. For example, upon this automated command, the controller 110 may direct movement of the lift cylinder 50, using present cylinder position information, to achieve a reduction in size of the lift cylinder 50. Further, the controller 110 may direct movement of the boom cylinder 40, using present cylinder position information, to achieve an extension of the large and/or small booms 42 and 44. In this manner, the combination of the lift cylinder 50 retracting to alter the boom angle downward, combined with the boom cylinder 40 linearly extending the large and/or small booms 42 and 44, causes a total effect by which the fork frame 30 and the fork tines 37 will move in a truly horizontal manner from the first location 32a to the second location 32b.

By contrast, if a user moves the joystick 80 in the opposing direction 81e, the controller 110 will instruct an opposite sequence, e.g., where the lift cylinder 50 extends and the boom cylinder 40 retracts, thus retracting the fork tines 37 in a truly horizontal manner from the second location 32b to the first location 32a.

Similarly, in FIGS. 2C-2D, when in the automated mode, the user may move the joystick 80 in the direction 81b to move the fork tines 37 in a truly vertical upward manner from a first location 33a to the second location 33b. To lift the attachment vertically, the controller 110 will command flow to either the rod or base side of the boom cylinder 40 and the lift cylinder 50. This will increase the boom angle while extending the boom, resulting in linear upward vertical movement of the attachment.

To lower the attachment vertically, a user may move the joystick 80 in the direction 81a to move the fork tines 37 in a truly vertical downward manner from the second location 33b to the first location 33a. In particular, the controller 110 will decrease hydraulic flow to the lift cylinder 50 while decreasing hydraulic flow to the boom cylinder 40. As with the embodiment of FIGS. 2A-2B, upon receiving commands to move truly vertically in the automated mode, the controller 110 directs movement of the boom and lift cylinders 40 and 50, using present cylinder information, to achieve the desired movement.

As explained further with respect to FIG. 8, the controller 110 receives input from the sensors in real-time, for example, several times per second or another predetermined amount of time, to repeatedly determine the position of the various components of the machine 20, to guarantee true horizontal or vertical movement of the fork frame 30. By the controller 110 repeatedly determining position of various components in extremely short increments, and also continually directing fluid flow adjustments to the cylinders up to several times per second, truly horizontal and vertical movement of the fork frame 30 can be achieved.

The hydraulic components of the transport machine 20 may be supplied with hydraulic pressure by means of a pressure compensated hydraulic fluid pump, which draws hydraulic fluid from a fluid reservoir, as is generally known in the art. A series of control valves are provided to distribute hydraulic fluid to the required components under pressure from a line. The joystick 80 is movable in four directions 81a-81d, as described herein, and the proper hydraulic pressure is enabled through the valves in order to operate the components, e.g., the boom and lift cylinders 40 and 50, in the intended manner. The controller 110 directs movement of the boom and lift cylinders 40 and 50, using present cylinder information, to achieve the desired movement.

Referring now to FIGS. 3A-3D, if the equipment is being operated on a slope, an additional frame angle sensor 74, depicted in FIG. 6, may be used to offset and account for slope on uneven ground 10′. In the non-limiting example of FIGS. 3A-3D, the frame angle sensor 74 is positioned between the axles and along the centerline of the main frame 22 as shown in FIG. 6, although it will be appreciated that the sensor may be at other locations.

The frame angle sensor 74 allows the operator to still command true linear motion in the horizontal plane from a first location 34a to a second location 34b, as shown in FIGS. 3A-3B, and also command true linear motion in the vertical plane from a first location 35a to a second location 35b, as shown in FIGS. 3C-3D. The true horizontal and vertical motion of FIGS. 3A-3D is directed regardless of position of the main frame 22, i.e., whether it is located on an uphill or downhill slope. The control program or algorithm of the controller 110 is operable to intake the frame position information from the sensor 74, and the control program or algorithm of the controller 110 is operable to take into account the frame position in determining how the controller 110 will direct movement of the boom and lift cylinders 40 and 50, also using their present cylinder position information, to achieve the desired horizontal or vertical motion as explained with respect to FIGS. 2A-2D above.

Referring to FIG. 8 in further detail, a block diagram depicting components of the system in one exemplary, non-limiting arrangement is shown. FIG. 8 illustrates a system that includes the controller 110 having input and output (I/O) capability. Other hardware having I/O capability, such as a computer or other logic device, may also be employed. The controller 110 may receive input from the joystick 80 and may output signals 112. Output signals 112 manipulate the hydraulic cylinders, such as the boom and lift cylinders 40 and 50, corresponding to the user's input from the joystick 80. Additional I/O capability is added to the controller 110, which includes an input from the mode selector button 82 and inputs from sensors 70, 72 and 74, which may be coupled to the transport machine 20 as described above. The sensors 70, 72 and 74 are coupled to the equipment to provide the controller 110 real-time position of components, as described above.

Further, a control program or algorithm is added to the controller 110 to facilitate the automated mode operation. The control program or algorithm utilizes the real-time position provided by the sensors 70, 72 and 74 to provide desired movements, such as true horizontal and vertical movement of the fork frame 30, by manipulating the output signals 112.

Referring now to FIG. 9, a flowchart depicts features of the system is shown. In FIG. 9, a user enables the automated operation mode in step 102 by pressing the automated mode button 82, shown in FIG. 7. An input signal is sent from the button 82 to the controller 110, as shown in FIG. 8, and the controller 110 will enter the automated operation mode. Next, in step 104, the user may command the controller to move the attachment truly vertically or horizontally by moving the joystick 80 in one of the directions 81a-81d, as discussed above. Then, in step 106, the controller 110 manipulates the hydraulic flow to the control valves, taking into account the position of the components based on input from the sensors, and the flow is adjusted and directed accordingly into the different cylinders. The controller 110 monitors the sensors in real-time to repeatedly determine the position of the components to guarantee true horizontal or vertical movement of the fork frame 30. This cycle may be repeated until the user wishes to disengage the automated operation mode at step 108 by pressing the button 82 another time.

Advantageously, the present embodiments provide an operator with additional control of the transport machine 20 by simplifying lifting, landing and other movement operations. The present embodiments also provide a significantly safer machine platform by simplifying positioning a load at a height. For example, when using the automated operation mode described herein, a user can simply move the joystick 80 in the direction 81c to retract the fork tines 37 linearly from a pallet, via the sensing technology and automated flow distribution described above. Further, a user maintains the choice of whether to operate the machine 20 in the manual mode or the automated mode by pressing the button 82 on the joystick 80.

As yet further advantages, the present embodiments also take slope of the ground into consideration, as discussed above, so if the transport machine 20 is operated on a grade, then a control program or algorithm can automatically adjust so that linear motion of the fork tines 37 can still be achieved, as explained with respect to FIG. 8. Additionally, the present embodiments also eliminate outside variables such as hydraulic variation due to temperature and viscosity, since real-time positioning of the components and movement of the attachment is continuously maintained with sensors regardless of outside variables.

It will be appreciated that while exemplary sensor locations are shown in FIGS. 4-6, the sensors 70, 72 and 74 may be placed at locations other than those depicted in FIGS. 4-6. Moreover, greater or fewer sensors than are shown in FIGS. 4-6 may be used to facilitate real-time gathering of positional data relating to various components of the transport machine 20. Further, additional cylinders may be provided in connection with the transport machine 20, for example, a tilt cylinder may be provided as noted above, and one or more sensors may be coupled to any such additional cylinders to enable real-time gathering of positional data of such added components.

Further, it will be appreciated that while the transport machine 20 shown herein is in the form of an extendable forklift, the technology described above may be applied in conjunction with other machines where such accurate real-time positioning is needed.

While various embodiments of the invention have been described, the invention is not to be restricted except in light of the attached claims and their equivalents. Moreover, the advantages described herein are not necessarily the only advantages of the invention and it is not necessarily expected that every embodiment of the invention will achieve all of the advantages described.

We claim:

1. A system for transporting an object, the system comprising:
a first cylinder that is movable to cause movement of a first component of the system; and
a first sensor operable to acquire position information related to a position of at least one of the first cylinder, the first component, or another component of the system,
wherein the system comprises an automated mode in which the position information provided by the first sensor is used to determine movement of the first component of the system.

2. The system of claim 1, wherein at least one boom is provided, and wherein the at least one boom and the first cylinder are operatively coupled to a fork frame to achieve movement of the fork frame.

3. The system of claim 2, wherein truly horizontal and vertical movement of the fork frame is achieved using the position information provided by the first sensor.

4. The system of claim 1, wherein the first sensor comprises one of a linear transducer or a string potentiometer.

5. The system of claim 1, wherein the first sensor is operatively coupled to a boom cylinder and a second sensor is operatively coupled to a lift cylinder.

6. The system of claim 5, wherein the first sensor comprises a linear transducer and the second sensor comprises a string potentiometer.

7. The system of claim 1, wherein at least one additional sensor is operatively coupled to a main frame of the system and is operable to acquire position information related to a slope of the main frame.

8. The system of claim 1, further comprising a manual operation mode, wherein the user is able to manually direct movements of the first component of the system by operating a joystick in the manual operation mode.

9. The system of claim 8, wherein the joystick comprises a button that is operable to automatically switch between the manual operation mode and the automated mode.

10. A method for transporting an object, the method comprising:
providing a first cylinder that is movable to cause movement of a first component of the system; and
acquiring position information, using a first sensor, related to a position of at least one of the first cylinder, the first component, or another component of the system;
adjusting fluid flow to the first cylinder based on the position information; and
achieving a corresponding movement of the first component of the system based on the fluid flow adjustment.

11. The method of claim 10, wherein the first sensor comprises one of a linear transducer or a string potentiometer.

12. The method of claim 10, wherein the first sensor is coupled to a boom cylinder and a second sensor is coupled to a lift cylinder.

13. The method of claim 12, the first sensor comprises a linear transducer and the second sensor comprises a string potentiometer.

14. The method of claim 10, further comprising providing at least one additional sensor coupled to a main frame of the system and operable to acquire position information related to a slope of the main frame.

15. The method of claim 10, further comprising providing a manual operation mode, wherein the user is able to manually direct movements of the first component of the system by operating a joystick in the manual operation mode.

16. The method of claim 15, further comprising automatically switching between the manual operation mode and the automated mode by pressing a button on the joystick.

17. A system for transporting an object, the system comprising:
a first cylinder and at least one boom that are movable to cause movement of a fork frame; and
a first sensor operable to acquire position information related to a position of at least one of the first cylinder, the at least one boom, or the fork frame,
wherein the system comprises an automated mode in which the position information provided by the first sensor is used to determine movement of the fork frame.

18. The system of claim 17, wherein truly horizontal and vertical movement of the fork frame is achieved using the position information provided by the first sensor.

19. The system of claim 17, wherein at least one additional sensor is coupled to a main frame of the system and is operable to acquire position information related to a slope of the main frame.

20. The system of claim 17, further comprising a manual operation mode, wherein the user is able to manually direct movements of the first component of the system by operating a joystick in the manual operation mode.
